(19) United States
(12) Patent Application Publication
(10) Pub. No.: US 2011/0295499 A1
(43) Pub. Date: Dec. 1, 2011

(54) NAVIGATION DEVICE

(75) Inventor: Satoshi NOZOE, Chiryu-city (JP)

(73) Assignee: DENSO CORPORATION, Kariya-city (JP)

(21) Appl. No.: 13/117,459

(22) Filed: May 27, 2011

(30) Foreign Application Priority Data
May 31, 2010 (JP) 2010-124450

(51) Int. Cl. G01C 21/00

(52) U.S. Cl. 701/201

(57) ABSTRACT

A navigation device includes: a map information memory; a current position detector; a route searching unit; a map image generating unit for generating a plan view map image including a current position and a destination; a display; and a display controller. The map image generating unit defines a tilt axis perpendicular to a straight line passing the current position and a certain point of a route not shown in the display, generates a transition result map image by tilting the plan view map image around the tilt axis to display the certain point, and generates a transition process map image between the plan view map image and the transition result map image. The display controller controls the display to switch from the plan view map image to the transition result map image via the transition process map image when a predetermined condition is satisfied.

### CROSS REFERENCE TO RELATED APPLICATION

This application is based on Japanese Patent Application No. 2010424450 filed on May 31, 2010, the disclosure of which is incorporated herein by reference.

### TECHNICAL FIELD

The present invention relates to a navigation device for displaying a route to a destination.

### BACKGROUND

Conventionally, a technique is described in JP-A-H08-194810 corresponding to U.S. Pat. No. 5,862,498. In the technique, there is a mode such that a bird eye view and a plane view of a road map around a present location are displayed on the same screen at the same time. When the screen image is displayed in this mode, a grid line of the bird eye view is overlapped on the grid line of the plane view. Further, a display region of the bird eye view is enlarged, and the plane view is displayed at a part of the display region of the bird eye view in a window display manner. In this technique, since the grid lines of the bird eye view and the plane view are overlapped each other, a user can easily recognize a distance in the bird eye view.

Here, it is required to comprehensively display a route from the current position to a next intersection, at which the vehicle turns right or left. The next intersection is disposed on a destination side from the current position on a route from the current position to a destination.

In the above technique, it is convenience for the user to confirm an actual situation with using the bird eye view. However, the above technique does not provide to display the route from the current position to the next intersection comprehensively.

In view of the above requirement, a technique is well known such that the current position and the route to the next intersection are displayed on the same screen, and a map scale change (i.e., a zoom in and out operation) and a map image displacement (i.e., a scroll operation) are automatically executed.

However, in the technique, since the zoom in and out operation and the scroll operation are automatically executed, the user may lose recognition of the current position, which has been formed by the user with the display of the current position before zooming and scrolling. Further, the user may lose a sense of a distance between the current position and the next intersection and a sense of direction. When the user loses the sense of the distance and the sense of direction, it is difficult for the user to recognize intuitively the distance to the intersection and the direction.

In the above explanation, although the requirement relates to the next intersection, at which the vehicle turns right or left, the requirement may relate to a next branch point, an entrance and an exit of an interchange in a high way, a stopover and the like, which are important points of the route from the current position to the destination. The important points are defined as route points. Thus, it is required to display a route to the next route point comprehensively. Further, it is required to display a following route to the destination comprehensively.

### SUMMARY

In view of the above-described problem, it is an object of the present disclosure to provide a navigation device for displaying a route to a destination. The navigation device displays a following route to the destination comprehensively without losing recognition of a current position, a sense of a distance and a sense of direction with respect to the current position.

According to an aspect of the present disclosure, a navigation device includes: a map information memory for storing map information; a current position detector for detecting a current position; a route searching unit for searching a route from a starting point to a destination; a map image generating unit for generating a plan view map image including the current position and a part of the route according to the map information, a detected current position and a searched route; a display for displaying the plan view map image in a display region of the display; and a display controller for controlling the display. The map image generating unit defines a tilt axis, which is perpendicular to a straight line passing the current position and a certain point of the route not shown in the display region. The map image generating unit generates a transition result map image by tilting the plan view map image around the tilt axis so that the certain point is shown on an up side of the transition result map image in the display region. The map image generating unit generates a transition process map image, which is a halfway image between the plan view map image and the transition result map image. The display controller controls the display to switch from the plan view map image to the transition result map image via the transition process map image when a predetermined condition is satisfied.

In the above device, the display switches the plan view map image to the transition result map image via the transition process map image. Here, the scale of the transition result map image and the transition process map image is the same as the plan view map image. Further, even when the display switches the plan view map image to the transition result map image via the transition process map image, the current position is always displayed in the display region. Thus, the user does not lose recognition of a current position, a sense of distance and a sense of direction with respect to the current position. Further, since the transition result map image is displayed through the transition process map image, the route to the destination is intuitively recognized by the user.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation device according to a first embodiment;

FIG. 2 is a diagram showing a following route from a current position to a next route point on the way to a destination;

FIG. 3 is a diagram showing a plan view of a map image in FIG. 2;

FIG. 4 is a diagram showing a map image of a transition result;

FIG. 5A is a diagram showing a relationship between the plan view of the map image and the map image of the transition result viewing from a side direction of a display region in a case where a distance between the current position and the next route point is short, and FIG. 5B is a diagram showing the relationship between the plan view of the map image and the map image of the transition result viewing from the side direction of the display region in a case where the distance between the current position and the next route point is long;

FIG. 6 is a flowchart showing a map image transition display process;

FIG. 7A is a diagram showing a tilt axis L and another tilt axis L1 on a plane view map image G11, FIG. 7B is a diagram showing a transition result map image G21, which is prepared by tilting the plan view map image in FIG. 7A with respect to the tilt axis L as a reference, and FIG. 7C is a diagram showing a transition result map image G12a, which is prepared by tilting the plan view map image in FIG. 7A with respect to the other tilt axis L1 as a reference;

FIG. 8A is a diagram showing a plan view map image, in which the next route point is disposed on a right side of the current position, according to a second embodiment, FIG. 8B is a diagram showing a transition process map image, which is prepared by rotating the plan view map image in FIG. 8A by a certain rotation angle so as to displace the next route position to be disposed on an up side of the current position, and FIG. 8C is a diagram showing a transition result map image, which is prepared by tilting the transition process map image in FIG. 8B by a tilt angle so as to display the next route point in a display region;

FIG. 9 is a flowchart showing a map image transition display process according to the second embodiment;

FIG. 10A is a diagram showing a plan view map image, in which the next route point is disposed on a right side of the current position, according to a third embodiment, FIG. 10B is a diagram showing a transition process map image, which is prepared by rotating the plan view map image in FIG. 10A by a certain rotation angle so as to displace the next route position to be disposed on a right up side of the display region B, and FIG. 10C is a diagram showing a transition result map image, which is prepared by tilting the transition process map image in FIG. 10B by a tilt angle so as to display the next route point in the display region B;

FIG. 11 is a flowchart showing a map image transition display process according to the third embodiment;

FIG. 12A is a diagram showing a transition result map image in a case where the distance between the current position and the next route point is short, according to a fourth embodiment, and FIG. 12B is a diagram showing the transition result map image in a case where the distance between the current position and the next route point is long, according to the fourth embodiment; and

FIG. 13A is a diagram showing a transition result map image in a case where a second next route point I from the current position is indicated, and FIG. 13B is a diagram showing the transition result map image in a case where a third next route point I from the current position is indicated.

### DETAILED DESCRIPTION

### First Embodiment

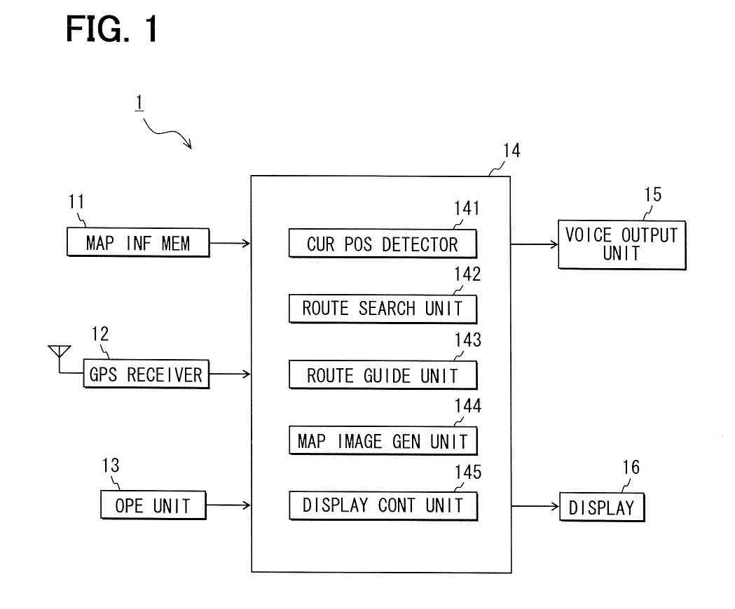

A navigation device 1 according to a first embodiment will be explained with reference to FIGS. 1 to 6. The navigation device 1 is mounted on a vehicle, which is not shown.

The construction and the functions of the navigation device 1 will be explained. As shown in FIG. 1, the navigation device 1 includes a map information memory 11, a GPS receiver 12, an operation unit 13, a controller 14, a voice output unit 15 and a display 16. The controller 14 is a conventional computer having a CPU and a memory. When a program stored in the memory is executed by the CPU, various functions are provided. The controller 14 includes a current position detector 141, a route searching unit 142, a route guiding unit 143, a map image generating unit 144 and a display control unit 145.

The map information memory 11 is, for example, a hard disk drive, a DVD (i.e., digital versatile disc) device, a CD (i.e., compact disc) device, or a flash memory. The memory 11 stores map information.

The GPS receiver 12 includes, for example, a GPS antenna so that the GPS receiver 12 receives multiple GPS signals transmitted from multiple GPS satellites (not shown). The GPS receiver 12 is connected to the controller 14, and the received GPS signal is input into the controller 14.

The operation unit 13 includes, for example, a touch panel, a voice input device and a push button as an input element. The operation unit 13 is connected to the controller 14. A user of the navigation device 1 operates the input element so that starting point information representing information about the starting point of the vehicle and destination information representing information about the destination are input into the controller 14. When the user operates the push button, a starting instruction for starting route guidance and a starting instruction for starting a map image transition display process are input into the controller 14.

The current position detector 141 is connected to the map information memory 11 and the GPS receiver 12. The current position detector 141 obtains the GPS signal received by the GPS receiver 12. Further, the current position detector 141 reads out the map information stored in the map information memory 11. With using the GPS signal and the map information, the detector 141 detects the current position of the vehicle. When the current position of the vehicle is detected, a conventional map matching process is performed based on a driving trajectory of the vehicle and the map information so that an error of the current position calculated from the GPS signal is corrected. The current position detector 141 is connected to the route guiding unit 143. Thus, the current position information representing the information of the current position of the vehicle is input into the route guiding unit 143.

The route searching unit 142 is connected to the map information memory 11 and the operation unit 13. With using the starting point information and the destination information input from the operation unit 13 and the map information obtained from the map information memory 11, the route from the starting point to the destination is searched. Further, the route searching unit 142 is connected to the route guiding unit 143. When the route from the starting point to the destination is searched, the route information representing the information of the searched route to the destination is input into the route guiding unit 143.

The route guiding unit 143 is connected to the operation unit 13, the current position detector 141, the route searching unit 142, the map image generating unit 144 and the display control unit 145. When the starting instruction for the route guidance and the starting instruction for the map image transition display process are input via the operation unit 13, the route guiding unit 143 inputs the starting instructions, the current position information from the current position detector 141, and the route information from the route searching unit 142 into the map image generating unit 144. Further, the route guiding unit 143 inputs the starting instructions into the display control unit 145. The route guiding unit 143 is connected to the voice output unit 15, which includes a speaker and the like. When the starting instruction for the route guidance is input from the operation unit 13, the voice guidance and/or the warning sound are output from the voice output unit 15 so that the route guidance is performed.

The map image generating unit 144 is connected to the route guiding unit 143 and the display control unit 145. When the starting instruction for the route guidance is input via the route guiding unit 143, with using the current position information and the route information input via the route guiding unit 143, the map image generating unit 144 generates a plan view map image as an plan view showing an map image including the current position and the route. The plan view map image information representing information of the generated plan view map image is input into the display control unit 145.

The display control unit 145 is connected to the map image generating unit 144. When the plan view map image information is input from the map image generating unit 144, the display control unit 145 controls the display 16 to display the plan view map image such that the current position in the plan view map image is located at a center of the display region having a square shape of the display 16. The display 16 includes a LCD or the like. The display region is defined by 480 dots multiplied by 480 dots. In the present embodiment, the dimensions of the display region are 480 dots by 480 dots. Alternatively, the dimensions of the display region may be 320 dots by 320 dots or 640 dots by 640 dots. In the present embodiment, the current position is located at the center of the display region. Alternatively, the current position may be located on a centerline in the right-left direction of the display region and on a lower side of the display region in the up-down direction of the display region.

Thus, the navigation device 1 displays the plan view map image including the current position and the route to the destination in the display region of the display 16. Further, the device 1 executes voice guidance with using the voice output unit 15.

Here, it is required for the device 1 to comprehensively display a part of the route from the current position to a route point such as a next intersection, at which the vehicle turns right or left, a next branch point, an entrance and an exit of an interchange in a high way, and a stopover, which are important points of the route from the current position to the destination.

In the present embodiment, the map image generating unit 144 generates a transition process map image and a transition result map image in addition to the plan view map image. The display control unit 145 transits (or switches) the map image displayed in the display region of the display 16 from the plan view map image to the transition result map image via the transition process map image. The map image generating unit 144 and the display control unit 145 will be explained.

When both of the starting instruction for starting route guidance and the starting instruction for starting the map image transition display process are input into the map image generating unit 144 via the route guiding unit 143, the map image generating unit 144 determines whether the next route point is not disposed in the display region with using the current position information and the route information input from the route guiding unit 143. The next route point is disposed on a destination side from the current position on the route. Here, in general, the input of the starting instruction for starting route guidance is performed at a time, which is different from a time when the input of the starting instruction for starting the map image transition display process is performed.

When the map image generating unit 144 determines that the next route point is not disposed in the display region, the map image generating unit 144 defines a tilt axis s a reference axis. The tilt axis is perpendicular to a straight line on the plan view map image connecting between the current position and the next route point. Further, the tilt axis passes the current position. The map image generating unit 144 generates the transition result map image such that the plan view map image is tilted around the tilt axis so as to displace the next route position to be disposed on an up side of the current position in the display region.

When the map image generating unit 144 determines that the next route point is disposed in the display region, the map image generating unit 144 generates the transition result map image such that the plan view map image is tilted around the tilt axis so as to displace the destination to be disposed on an up side of the current position in the display region. Here, a tilt angle of the plan view map image around the tilt axis is defined as a tilt angle.

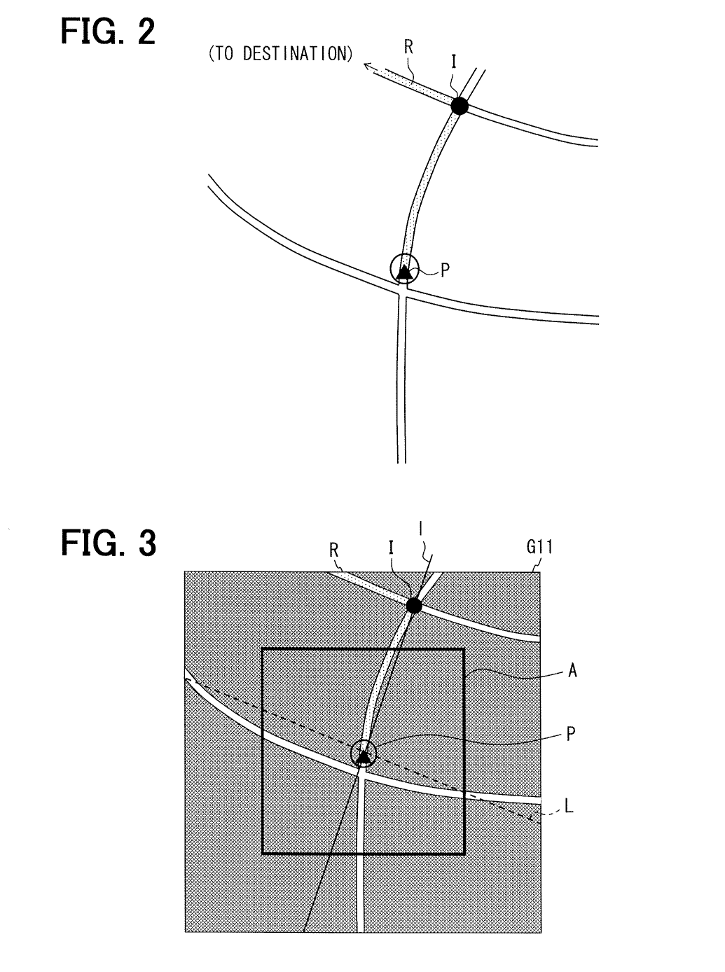

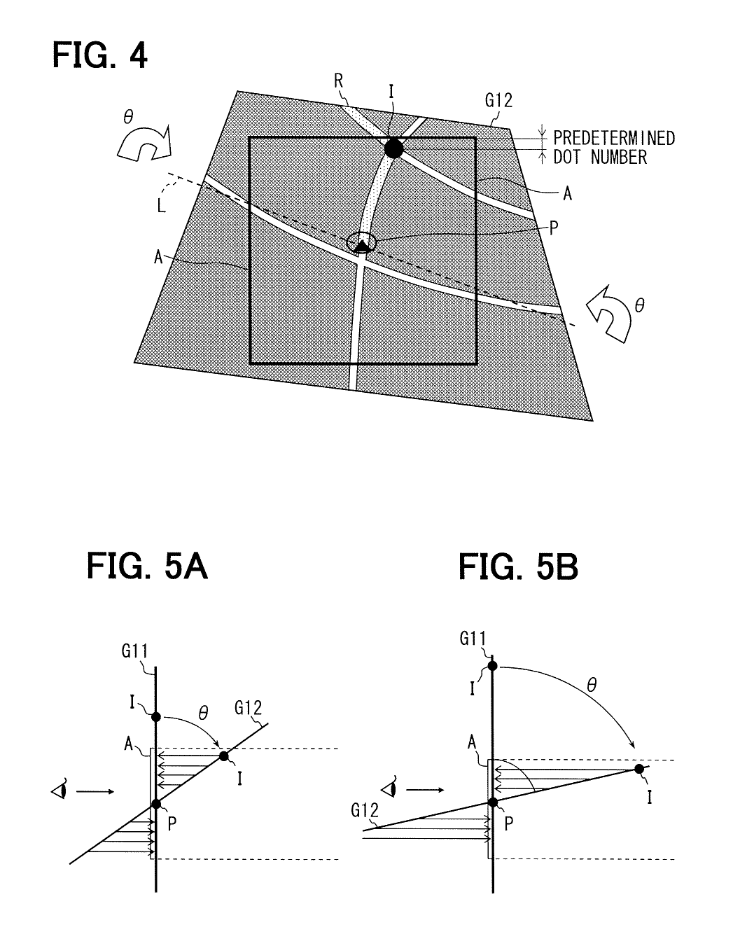

The transition result map image will be explained with reference to FIGS. 2 to 6. FIG. 2 shows the next route point I on the destination side from the current position P on the route R from the current position to the destination (not shown). FIG. 3 shows the plan view map image G11 generated by the map image generating unit 144. FIG. 4 shows the transition result map image G12 generated by the map image generating unit 144. FIGS. 5A and 5B show a relationship between the plan view map image G11 and the transition result map image G12 viewing from the side direction of the display region A. FIG. 5A show a case where the distance between the current position P and the next route point I, which is not displayed in the display region A, is short. FIG. 5B show a case where the distance between the current position P and the next route point I, which is not displayed in the display region A, is long.

The map image generating unit 144 determines that the next route point I, which is not displayed in the display region, exists in case of the situation in FIG. 2. Accordingly, as shown in FIG. 3, the map image generating unit 144 calculates the straight line I, which passes the current position P and the next route point I on the plan view map image G11. Further, the map image generating unit 144 sets the tilt axis L, which is perpendicular to the straight line I and passes the current position P. When the unit 144 sets the tilt axis L, the map image generating unit 144 calculates the tilt angle θ such that the next route point I is located on an inside of the display region A from a nearest side of the display region A by predetermined dots such as 24 dots. Specifically, when the plan view map image is tilted by the tilt angle θ, the distance between the next route point I and the nearest side of the display region A from the next route point I is set to be predetermined dots. When the tilt angle θ is calculated, the map image generating unit 144 generates the transition result map image G12, which is prepared by tilting the plan view map image G11 with respect to the tilt axis L by the tilt angle θ to the up side of the display region A. In view of the comparison between the tilt angle θ in FIG. 5A and the tilt angle θ in FIG. 5B, as the distance between the current position P and the next route point I on the plan view map image G11 is long, the tilt angle θ becomes large. When the distance between the current position P and the next route point I on the plan view map image G11 is short, the tilt angle θ is small. Here, the predetermined dots may be any. For example, the predetermined dots may be equal to a predetermined ratio of one side of the display region A such as 5% of dots of the one side of the display region A.

The map image generating unit 144 further generates multiple transition process map images, which are arranged from the plan view map image G11 in FIG. 3 to the transition result map image G12 in FIG. 4. The number of the transition process map images is defined as N such as ten. Here, N represents a natural number. Specifically, the map image generating unit 144 generates the transition process map image, which is prepared by tilting the plan view map image G11 by the tilt angle of θn with respect to the tilt axis L. Here, the tilt angle of θn is equal to n×θ/(N+1), and n is a natural number equal to or smaller than N. The predetermined number N may be any. For example, the predetermined number N may be five or fifteen. Alternatively, when the tilt angle θ is large, i.e., when the distance between the current position P and the next route point I on the plan view map image G11 is long, the predetermined number N may be large. When the predetermined number N is large, the transition from the plan view map image G11 to the transition result map image G12 is smoothly displayed.

When the map image generating unit 144 generates the plan view map image G11, the transition result map image G12 and N transition process map images, the unit 144 inputs these map images into the display control unit 145.

When the map image generating unit 144 determines that the next route point not displayed in the display region does not exist, the transition result map image G12 and N transition process map images are prepared by replacing the route point I with the destination in the above described method in a case where the map image generating unit 144 determines that the next route point not displayed in the display region exists.

When the plan view map image G11, the transition result map image G12 and N transition process map images are input into the display control unit 145 from the map image generating unit 144, the display control unit 145 controls the display 16 to display and transit (i.e., switch) the map image in the display region A of the display 16 from the plan view map image G11 to the transition result map image G12 via multiple transition process map images within a predetermined transition time such as one second. Specifically, the display 16 switches to display the plan view map image G11 to the transition result map image G12 via multiple transition process map images within the transition time. After the display 16 displays the transition result map image G12, the display control unit 145 controls the display 16 to continue displaying the transition result map image G12 for a predetermined duration time such as five seconds. After the duration time has elapsed, the display control unit 145 controls the display 16 to switch the map image in the display region A of the display 16 from the transition result map image G12 to the plan view map image G11 via multiple transition process map images within the predetermined transition time.

Here, the transition time may be any such as two seconds or 0.8 seconds. Since it is preferable for the user to set the transition time such that the user can see a whole transition of the map image safety even when the user drives the vehicle, the transition time is set to be one second. The duration time may be any such as one second or 10 seconds.

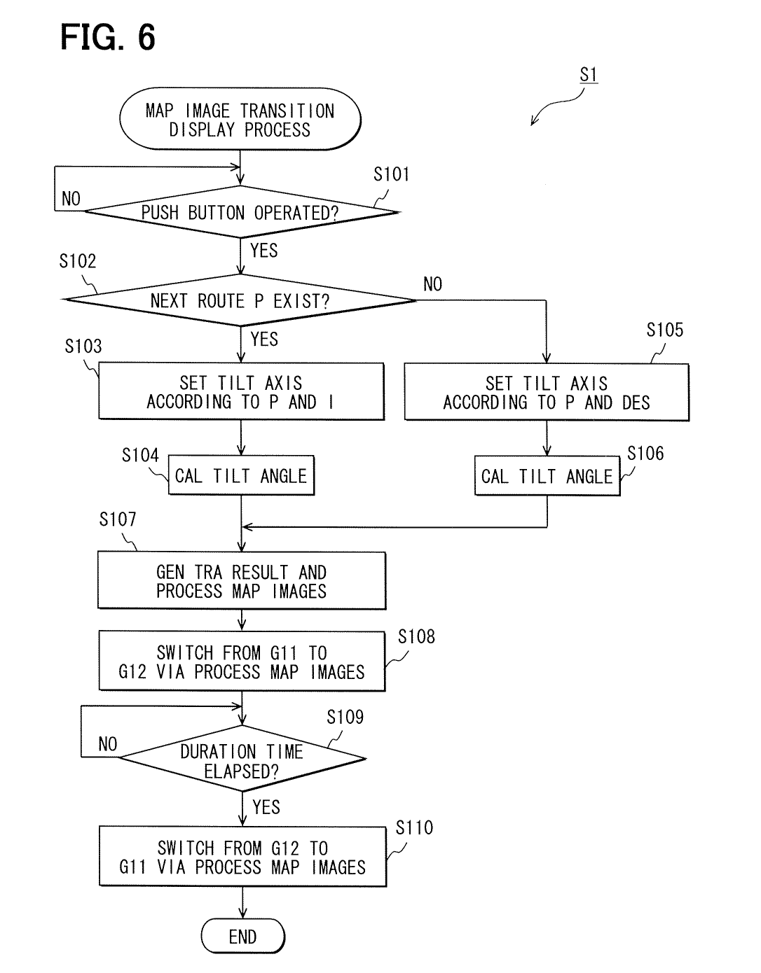

Thus, the navigation device 1 executes the map image transition display process S1 in FIG. 6. After the starting point and the destination are input by the input element in the operation unit 13, the user operates the push button of the operation unit 13 so that the route guidance is performed. Since the route guidance is performed, the plan view map image G11 has been already displayed in the display region A of the display 16.

The navigation device 1 determines whether the user operates the push button of the operation unit 13, i.e., whether the starting instruction for transition of the map image is input while the route guidance is performed. Here, when the device 1 determines that the user does not operate the push button, i.e., when the determination of step S101 is “NO,” the device 1 repeats step S101. When the device 1 determines that the user operates the push button, i.e., when the determination of step S101 is “YES,” it goes to step S102. Thus, the device 1 stands by with repeating step S101 until the user operates the push button of the operation unit 13.

When the transition starting instruction of the map image is input, the navigation device 1 determines in step S102 whether the next route point I not shown in the display region exists on the destination side from the current point P on the route.

When the device 1 determines that the next route point I exists, i.e., when the determination of step S102 is “YES,” the navigation device 1 calculates the straight line I, which passes the current position P and the next route point I on the plan view map image in step S103. Further, the device 1 sets the tilt axis L perpendicular to the straight line I and passing the current position P. Then, in step S104, the device 1 calculates the tilt angle θ in such a manner that the next route point I is displaced to the inside of the display region A by the predetermined dots from the nearest side of the display region A when the plan view map image is tilted by the tilt angle θ around the tilt axis L. Then, it goes to step S107.

When the device 1 determines that the next route point I does not exist, i.e., when the determination of step S102 is “NO,” the navigation device 1 calculates the straight line, which passes the current position P and the destination on the plan view map image in step S105. Further, the device 1 sets the tilt axis L perpendicular to the straight line and passing the current position P. Then, in step S106, the device 1 calculates the tilt angle θ in such a manner that the destination is displaced to the inside of the display region A by the predetermined dots from the nearest side of the display region A when the plan view map image is tilted by the tilt angle θ around the tilt axis L. Then, it goes to step S107.

In step S107, the device 1 generates the transition result map image G12 as the map image, which is prepared by tilting the plan view map image G11 by the tilt angle θ toward the up side of the display region A. Further, the device 1 generates N transition process map images, which is prepared by tilting the plan view map image G11 by predetermined tilt angles θn. The N transition process map images are disposed between the plan view map image G11 and the transition result map image G12. Then, it goes to step S108.

In step S108, the device 1 switches (i.e., transforms) the map image displayed in the display region A of the display 16 from the plan view map image G11 to the transition result map image G12 via N transition process map images within the predetermined transition time. Specifically, the plan view map image G11, N transition process map images (i.e., from an image provided by θ1 to an image provided by θN) and the transition result map image G12 are displayed in this order within the transition time. After the transition result map image G12 is displayed, the device 1 determines in step S109 whether the duration time has been elapsed. Here, in step S109, the device 1 continues to display the transition result map image G12 in the display region A of the display 16.

When the device 1 determines that the duration time has not been elapsed, i.e., when the determination of step S109 is “NO,” the device 1 repeats step S109. When the device 1 determines that the duration time has been elapsed, i.e., when the determination of step S109 is “YES,” it goes to step S110. Specifically, the device 1 stands by with repeating step S109 until the duration time has been elapsed.

After the duration time has been elapsed, the device 1 switches (i.e., transforms) the map image displayed in the display region A of the display 16 from the transition result map image G12 to the plan view map image G11 via N transition process map images within the predetermined transition time. Specifically, the transition result map image G12, N transition process map images (i.e., from an image provided by θN to an image provided by θ1) and the plan view map image G11 are displayed in this order within the transition time. Then, the map image transition display process S1 ends.

In the first embodiment, the device 1 generates the transition result map image G12 and the transition process map images. The transition result map image G12 is prepared by tilting the plan view map image 11 by the tilt angle θ to the up side of the display region A around the tilt axis L so that the next route point I not shown on the plan view map image G11 in the display region A is displaced to the inside of the display region A of the display 16. The tilt axis L is perpendicular to the straight line I, which passes the current position P and the next route point P on the plan view map image G11, and further, passes the current position P. The transition process map images are prepared by tilting the plan view map image G11 around the tilt axis L by the tilt angle θn. The tilt angle θn is equal to n×θ/(N+1). Here, n is a natural number and equal to or smaller than N. The device 1 makes the transition of the map image from the plan view map image G11 to the transition result map image G12 via the transition process map images.

Thus, the transition result map image G12 and the transition process map images have the same scale as the plan view map image G11. Further, the current position P is located in the display region A even when the map image is switched from the plan view map image G11 to the transition result map image G12 via the transition process map images. Thus, the user does not lose the sense of distance and the sense of direction with reference to the current position P, which is recognized by the user when the plan view map image G11 is displayed. Since the transition result map image G12 is displayed, the user can recognizes a route R from the current position P to the next route point P. Further, the user can intuitively recognize the distance from the current position P to the next route point P in view of the magnitude of the tilt angle θ.

Further, in the first embodiment, the operation unit 13 includes the push button, and the execution instruction is input by the push button. This step corresponds to step S101 in FIG. 6. Thus, with a simple operation of pushing the button without performing complicated operations, the user can controls the device 1 to switch the map image in the display region A of the display 16 from the plan view map image G11 to the transition result map image G12 via the transition process map images.

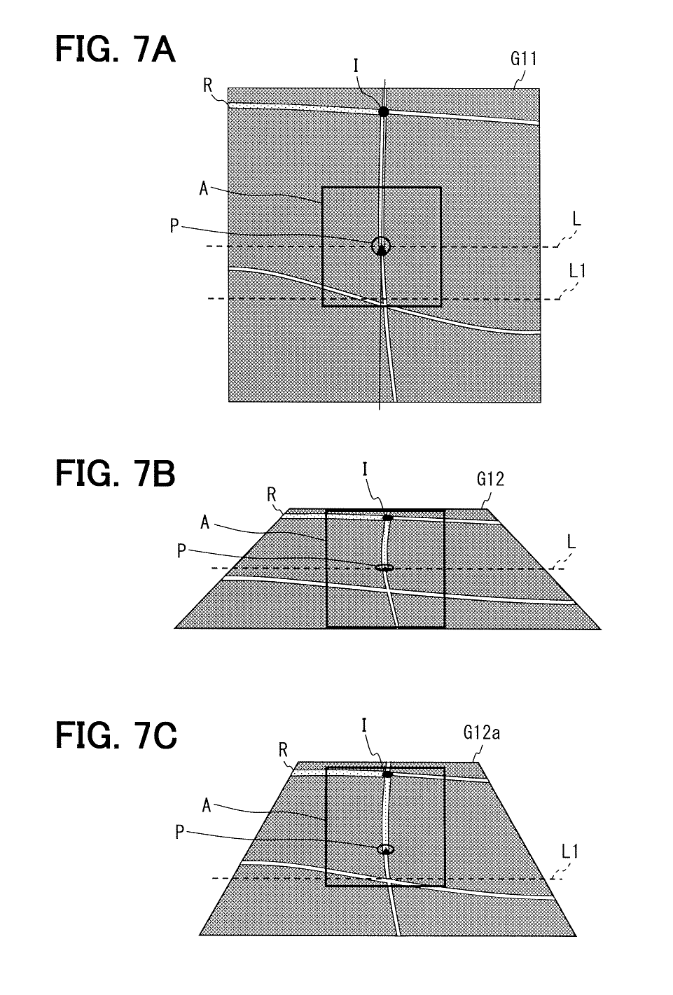

In the present embodiment, as shown in FIGS. 3 and 7A, the device 1 generates the transition result map image G12 in FIGS. 4 and 7B and the transition process map images with using the tilt axis L, which passes the current position P on the plan view map image G11. Further, the current position P is located at the center of the display region A even when the plan view map image G11 is tilted.

The navigation device 1 may generate the transition result map image G12a in FIG. 7C and the transition process map images with using another tilt axis L1, which is in parallel to the tilt axis L and shifted from the tilt axis L to a starting point side (which is opposite to the destination). When the plan view map image G11 is tilted around the tilt axis L1, the current position P is located in the display region A.

Comparing the transition result map image G12 in FIG. 7B and the transition result map image G12a in FIG. 7C, an area including the route from the current position P to the next route point I in the transition result map image G12a in FIG. 7C is wider than an area including the route from the current position P to the next route point I in the transition result map image G12 in FIG. 7B. Accordingly, since the ratio between the area in FIG. 7C and the display region A is higher than the ratio between the area in FIG. 7B and the display region A, the display region A in FIG. 7C is effectively utilized, compared with the display region A in FIG. 7B.

In the first embodiment, when the user operates the push button while the device 1 executes the route guidance to the destination, the device 1 switches the map image in the display region A from the plan view map image G11 to the transition result map image G12 via the transition process map images, continues to display the transition result map image G12 for the predetermined duration time, and switches the map image from the transition result map image G12 to the plan view map image G11 via the transition process map images.

Alternatively, the device 1 may switches the map image from the transition result map image G12 to the plan view map image G11 via the transition process map images when the user operates the push button while the display 16 displays the transition result map image G12. Specifically, the device 1 does not switch the map image from the transition result map image G12 to the plan view map image G11 via the transition process map images even after the predetermined duration time has been elapsed. More specifically, the device 1 continues to display the transition result map image G12 until the user operates the push button. Alternatively, the device 1 may switch the map image from the transition result map image G12 to the plan view map image G11 via the transition process map images when the vehicle passes the next route point I while the display 16 displays the transition result map image G12. Alternatively, the device 1 may switch the map image from the transition result map image G12 to the plan view map image G11 directly without displaying the transition process map images.

In the first embodiment, when the number of following route points I disposed on the destination side from the current position P on the route R is equal to or larger than a predetermined number, the device 1 sets the straight line I, which passes the current position P and a predetermined ordinal number of the route point I on the plan view map image G11. Here, the predetermined ordinal number of the route point I may be the first route point, the second route point, the third route point or the like ahead of the current position P. In the first embodiment, the predetermined ordinal number of the route point I is the first route point I, i.e., the next route point I. Further, the device 1 sets the tilt axis L perpendicular to the straight line I. The device 1 determines the tilt angle θ such that the predetermined ordinal number of the route point I is displayed in the display region A when the plan view map image is tilted by the tilt angle θ. The transition result map image G12 and the transition process map images are generated by tilting the plan view map image G11 by the tilt angle θ or θn. Further, when the number of route points I on the destination side from the current position P on the route R is smaller than the predetermine number, the device 1 sets the straight line I, which passes the current position P and the destination on the plan view map image G11. Further, the device 1 sets the tilt axis L perpendicular to the straight line I. The device 1 determines the tilt angle θ such that the destination is displayed in the display region A when the plan view map image is tilted by the tilt angle θ. The transition result map image G12 and the transition process map images are generated by tilting the plan view map image G11 by the tilt angle θ or θn.

The predetermined ordinal number of the route point I may be the second route point I, the third route point I or the like. In this case, even when the number of route points I on the destination side from the current position P on the route R is smaller than the predetermine number, there may be at least one route point I between the current position P and the destination. Even when at least one route point I is disposed between the current position P and the destination, the device 1 does not set the tilt axis L based on the route point I.

Thus, the device 1 may set the straight line I, which passes the current position P and the route point I between the current position P and the destination when the number of route points I on the destination side from the current position P on the route R is smaller than the predetermine number. The device sets the tilt axis L perpendicular to the straight line I. The device 1 determines the tilt angle θ such that the route point I on the straight line I is displayed in the display region A when the plan view map image is tilted by the tilt angle θ. Thus, the device 1 generates the transition result map image G12 and the transition process map images.

The predetermined number of route points I is three, and the number of route points I on the destination side from the current position P on the route to the destination is smaller than three. In this case, two route points I is located between the current position p and the destination. The device 1 sets the straight line I, which passes one of the two route points and the current position P on the plan view map image G11. The device 1 sets the tilt axis L perpendicular to the straight line I. Further, the device 1 determines the tilt angle θ such that the route point I on the straight line I is displayed in the display region A when the plan view map image is tilted by the tilt angle θ. Thus, the device 1 generates the transition result map image G12 and the transition process map images.

### Second Embodiment

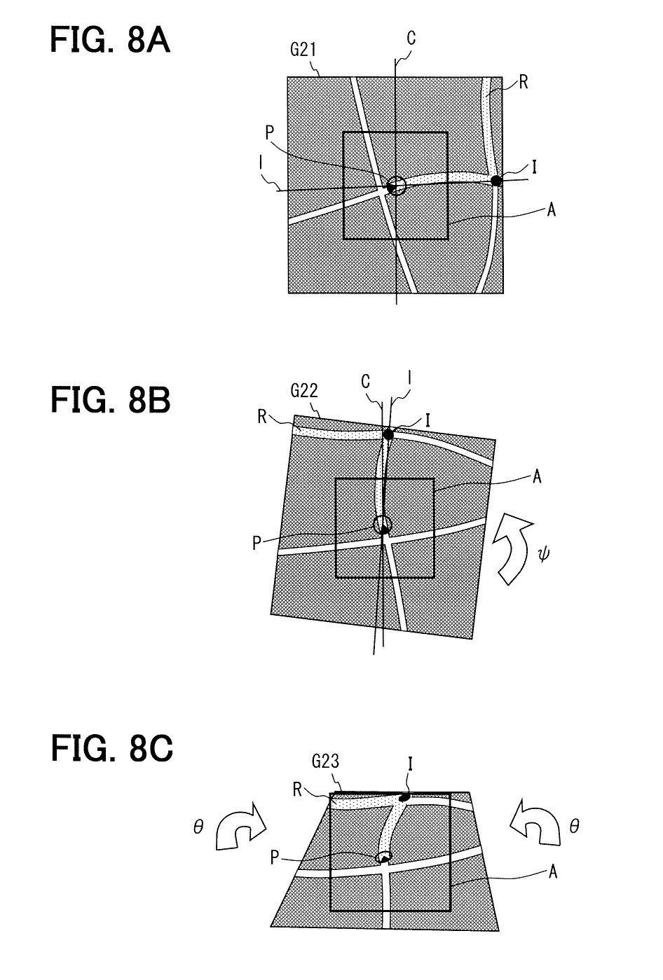

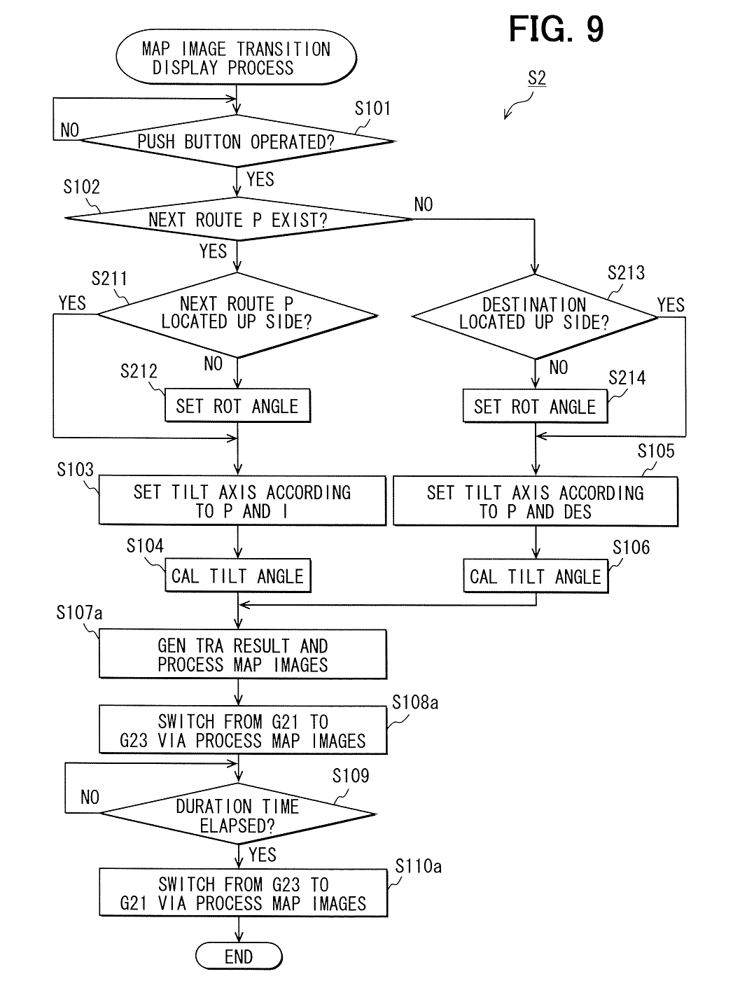

A navigation device according to a second embodiment will be explained with reference to FIGS. 8A to 9.

FIG. 8A shows the plan view map image G21, in which the next route point I not shown in the display region A is located on the right side of the current position P. In this case, in the first embodiment, the right area of the display region A of the display 16 is tilted to the right side around the tilt axis perpendicular to the straight line I, and the left area of the display region A is tilted to the left side. Thus, it is hard for the user to see the transition result map image G12.

In the second embodiment, as shown in FIG. 8B, the navigation device generates the transition process map image G22, which is prepared by rotating the plan view map image G21 around the current position P as the rotation center by a certain rotation angle φ so that the next route point I is located on the up side of the display region A. Then, as shown in FIG. 8C, the device generates the transition result map image G23, which is prepared by tilting the transition process map image G22 by the tilt angle θ so that the next route point I is displayed in the display region A when the transition process map image G22 is tilted by the tilt angle θ. The device switches the map image on the display 16 from the plan view map image G21 to the transition result map image G23 via the transition process map image G22.

FIG. 9 shows the flowchart of the map image transition display process S2 executed by the navigation device according to the second embodiment.

In step S102, when the device determines that the next route point I not displayed in the display region A exists, i.e., when the determination of step S102 is “YES,” it goes to step S211. In step S211, the device determines whether the next route point I not displayed in the display region A is located on the up side of the current position p on the display region A. Specifically, the device calculates a straight line C on the plan view map image G21, which extends from the current position P in the up-down direction, and the straight line I on the plan view map image G21, which passes the current position P and the next route point I. The device determines whether the angle between the straight line C and the straight line I is in a predetermined range such as in a range between −10 degrees and +10 degrees. Alternatively, the predetermine range may be in a range between −5 degrees and +5 degrees or the like.

The angle between the straight line C and the straight line I is measured from the straight line C as the reference line. The clockwise direction is defined as positive, and the counter clockwise direction is defined as negative. When the angle between the straight line C and the straight line I is zero degree, the next route point I on the plan view map image G21 is located directly above the current position P. When the angle between the straight line C and the straight line I is 90 degrees, the next route point I on the plan view map image G21 is located directly on the right side of the current position P. When the angle between the straight line C and the straight line I is 180 degrees, the next route point I on the plan view map image G21 is located directly below the current position P. When the angle between the straight line C and the straight line I is 270 degrees, the next route point I on the plan view map image G21 is located directly on the left side of the current position P.

Here, when the route point I is located on the up side of the current position P, i.e., when the determination of step S211 is “YES,” it goes to step S103. When the route point I is not located on the up side of the current position P, i.e., when the determination of step S211 is “NO,” it goes to step S212. In step S212, the angle between the straight line C and the straight line I is defined as the rotation angle φ. Then, it goes to step S103.

In step S102, when the device determines that the next route point I not displayed in the display region A does not exist, i.e., when the determination of step S102 is “NO,” it goes to step S213. In step S213, the device determines whether the destination is located on the up side of the current position P. Specifically, the device calculates a straight line C on the plan view map image G21, which extends from the current position P in the up-down direction, and the straight line I on the plan view map image G21, which passes the current position P and the destination. The device determines whether the angle between the straight line C and the straight line I is in the predetermined range.

When the destination is located on the up side of the current position P, i.e., when the determination of step S213 is “YES,” it goes to step S105. When the destination is not located on the up side of the current position P, i.e., when the determination of step S213 is “NO,” it goes to step S214. In step S214, the angle between the straight line C and the straight line I is defined as the rotation angle φ. Then, it goes to step S105.

After steps S103 to S106 are executed, it goes to step S107a.

In step S107a, the device generates the transition process map image G22 when the determination of step S211 or S213 is “NO” such that the plan view map image G21 is rotated around the current position P by the rotation angle φ so that the next route point I or the destination is located directly above the current position P on the transition process map image G22. Further, the device generates the transition result map image G23, which is prepared by tilting the transition process map image G22 by the tilt angle θ around the tile axis L. When the determination of step S211 or S213 is “YES,” the device generates the transition result map image G23, which is prepared by tilting the plan view map image G21 by the tilt angle θ around the tile axis L.

In step S107a, when the determination of step S211 or S213 is “NO,” the device generates multiple transition process map images, which are disposed between the plan view map image G21 and the transition process map image G22, and generates multiple transition process map images, which are disposed between the transition process map image G22 and the transition result map image G23. The number of the transition process map images between the plan view map image G21 and the transition process map image G22 is defined as N1 such as five. The number of the transition process map images between the transition process map image G22 and the transition result map image G23 is defined as N2 such as ten. Then, it goes to step S108a. When the determination of step S211 or S213 is “YES,” the device generates multiple transition process map images, which are disposed between the plan view map image G21 and the transition result map image G23. The number of the transition process map images between the plan view map image G21 and the transition result map image G23 is defined as N2 such as ten. Then, it goes to step S108a.

Specifically, the device generates the transition process map images between the plan view map image G21 and the transition process map image G22, which are prepared by rotating the plan view map image G21 around the current position P by the rotation angle φn, which is equal to n×φ/(N1+1). Here, n is 1, 2 or the like, and equal to or smaller than N1. The predetermined number N1 may be any such as three or ten.

Further, the device generates the transition process map images between the plan view map image G21 and the transition result map image G23, which are prepared by tilting the transition process map image G22 around the tilt axis L by the tilt angle θn, which is equal to n×θ/(N2+1). Here, n is 1, 2 or the like, and equal to or smaller than N2. The predetermined number N2 may be any such as ten or fifteen.

In step S108a, when the determination of step S211 or S213 is “NO,” the device switches the map image in the display region A of the display 16 from the plan view map image G21 to the transition process map image G22 via multiple transition process map images (i.e., from an image provided by φ1 to an image provided by φN1) and switches from transition process map image G22 to the transition result map image G23 via multiple transition process map images (i.e., from an image provided by θ1 to an image provided by θN2) within the predetermine transition time. When the determination of step S211 or S213 is “YES,” the device switches the map image in the display region A of the display 16 from the plan view map image G21 to the transition result map image G23 via multiple transition process map images (i.e., from an image provided by θ1 to an image provided by θN2) within the predetermine transition time. After the device switches to the transition result map image G2, it goes to step S109.

In step S110a, when the determination of step S211 or S213 is “NO,” the device switches the map image in the display region A of the display 16 from the transition result map image G23 to the transition process map image G22 via multiple transition process map images (i.e., from an image provided by θN2 to an image provided by θ1), and further switches from the transition process map image G22 to the plan view map image G21 to the via multiple transition process map images (i.e., from an image provided by φN1 to an image provided by φ1) within the predetermine transition time. Then, the map image transition display process ends. When the determination of step S211 or S213 is “YES,” the device switches the map image in the display region A of the display 16 from the transition result map image G23 to the plan view map image G21 via multiple transition process map images (i.e., from an image provided by θN2 to an image provided by θ1) within the predetermine transition time. Then, the map image transition display process ends.

In the second embodiment, the device generates the transition process map image G22, which is prepared by rotating the plan view map image G21 around the current position P by the rotation angle φ so that the next route point I is located on the up side of the current position P. Further, the device generates multiple transition process map images between the plan view map image G21 and the transition process map image G22, which are prepared by rotating the plan view map image G21 around the current position P by the rotation angle φn, which is equal to n×φ/(N1+1). Further, the device generates the transition result map image G23, which is prepared by tilting the transition process map image G22 around the tilt axis L by the tilt angle θ so that the next route point I is displayed in the display region A of the display 16. Further, the device generates multiple transition process map images between the transition process map image G22 and the transition result map image G23, which are prepared by tilting the transition process map image G22 around the tilt axis L by the tilt angle θn, which is equal to n×θ/(N2+1). The device switches the map image on the display 16 from the plan view map image G21 to the transition result map image G23 via multiple transition process map images (i.e., from an image provided by φ1 to an image provided by φN1), the transition process map image G22 and multiple transition process map images (i.e., from an image provided by θ1 to an image provided by φN2) within the predetermine transition time. Thus, the up side area of the display region A, in which the route point I on the straight line or the destination is disposed, is tilted to the up side of the display region A. Further, the down side area of the display region A is tilted to the down side of the display region A. Accordingly, the user can easily recognize the transition result map image G23 in the display region A.

In the second embodiment, the device generates the transition result map image G23 after the plan view map image G21 is rotated. Alternatively, the device may generate the transition result map image G23 after the plan view map image G21 is tilted. Alternatively, the device may generate the transition result map image G23 by rotating and tilting the plan view map image G21 at the same time.

Similar to the modification of the first embodiment, the device may generate the transition result map image G23a and the transition process map images with using the tilt axis L1, which is displaced from the tilt axis L to the starting point side of the current position P on the plan view map image G21.

### Third Embodiment

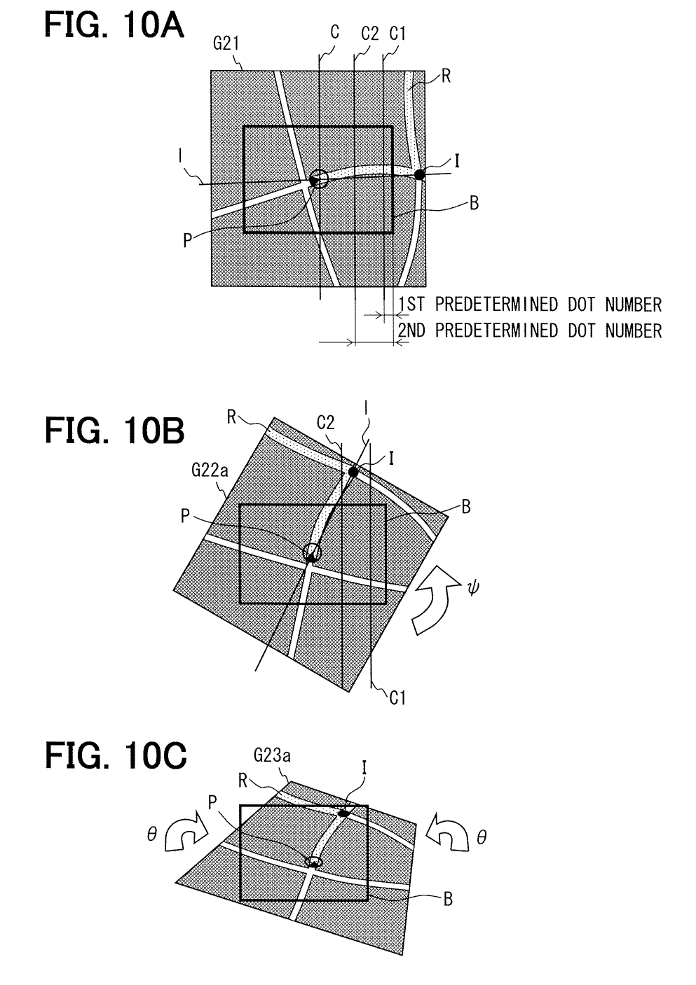

Next, a navigation device according to a third embodiment will be explained with reference to FIGS. 10A to 10C. In the first and second embodiments, the display region A has the square shape of the display 16 such as 480 dots multiplied by 480 dots. In the third embodiment, the display region B has the rectangular shape of the display 16 such as 640 dots multiplied by 480 dots.

FIG. 10A shows the plan view map image G21 in a case where the next route point I is located on the right side of the current position P. In the third embodiment, the device generates the transition process map image G22a, which is prepared by rotating the plan view map image G21 around the current position P as the center by the rotation angle φ so that the next route point I is arranged on the up side of the right side region of the display region B on the transition process map image G22a, as shown in FIG. 10B. Then, the device generates the transition result map image G23a, which is prepared by tilting the transition process map image G22a by the tilt angle θ so that the next route point I is arranged on the inside of the display region B of the display 16 on the transition result map image G23a, as shown in FIG. 10C. Thus, the device switches the map image on the display region B from the plan view map image G21 to the transition result map image G23a via the transition process map image G22a.

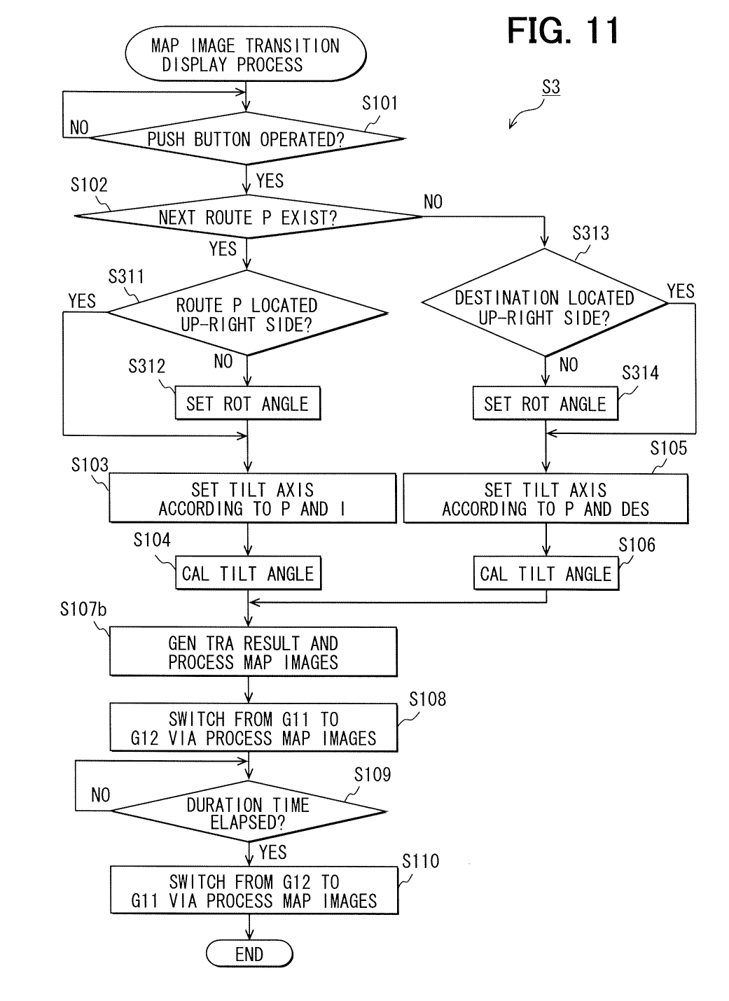

FIG. 11 shows the flowchart of the map image transition display process S3 executed by the navigation device according to the third embodiment. The process will be explained with reference to FIG. 11.

In step S102, when the device determines that the next route point I exists, when the determination of step S102 is “YES,” it goes to step S311. In step S311, the device determines whether the next route point I is disposed on the up side of the right side region of the display region B.

Here, the right side region of the display region B is a region on the right side of the center of the display region B. In the present embodiment, the first straight line C1 is defined such that the first straight line C1 is in parallel to the right side of the display region B and disposed at the inside of the display region B from the right side by a predetermined first dots such as 32 dots. Further, the second straight line C2 is defined such that the second straight line C2 is in parallel to the right side of the display region B and disposed at the inside of the display region B from the right side by a predetermined second dots such as 192 dots, which is larger than the first dots. The right side region of the display region B is disposed between the first straight line C1 and the second straight line C2. Further, the up side of the right side region of the display region B is disposed between the first straight line C1 and the second straight line C2 and is the upper area of the up side of the display region B. The first and second dots may be any and variable. Alternatively, the first dots may be equal to a predetermined ratio of one long side of the display region B such as 5% of dots of the one long side of the display region B, and the second dots may be equal to a predetermined ratio of one long side of the display region B such as 30% of dots of the one long side of the display region B.

When the route point I is disposed on the up side of the right side region of the display region B, i.e., when the determination of step S311 is “YES,” it goes to step S103. When the route point I is not disposed on the up side of the right side region of the display region B, i.e., when the determination of step S311 is “NO,” it goes to step S312. In step S312, the device defines the straight line C, which extends from the current position P on the plan view map image G21 in the vertical direction. Further, the device defines a straight line, which passes the current position P and a point, which is disposed on the up side of the right side region of the display region B and has a distance to the current position P equal to the distance between the current position P and the next route point I. The device calculates the angle between the straight line and the straight line C. Further, the device calculates the rotation angle φ, which is obtaining by subtracting the angle between the straight line and the straight line C from an angle between the straight line C and the straight line I. Then, it goes to step S103.

Similarly, in step S102, when the device determines that the next route point I does not exist, i.e., when the determination of step S102 is “NO, it goes to step S313. In step S313, the device determines whether the destination is located on the up side of the right side region of the display region B.

When the destination is located on the up side of the right side region of the display region B, i.e., when the determination of step S313 is “YES,” it goes to step S105. When the destination is not located on the up side of the right side region of the display region B, i.e., when the determination of step S313 is “NO,” it goes to step S314. In step S314, the device calculates the angle between the straight line C and the straight line, which passes the current position P and a point disposed on the up side of the right side region of the display region B and having a distance to the current position P equal to the distance between the current position P and the next route point I. Further, the device calculates the rotation angle φ, which is obtaining by subtracting the angle between the straight line and the straight line C from an angle between the straight line C and the straight line I. Then, it goes to step S105.

Then, steps S103 to S106 are executed, and it goes to step S107b.

In the third embodiment, the navigation device the device generates the transition process map image G22a, which is prepared by rotating the plan view map image G21 around the current position as the rotation center P by the rotation angle φ so that the next route point I is located on the up side of the right side region of the display region B. Further, the device generates multiple transition process map images between the plan view map image G21 and the transition process map image G22a, which are prepared by rotating the plan view map image G21 around the current position P by the rotation angle φn, which is equal to n×φ/(N1+1). Further, the device generates the transition result map image G23a, which is prepared by tilting the transition process map image G22a around the tilt axis L by the tilt angle θ so that the next route point I is displayed in the display region B of the display 16. Further, the device generates multiple transition process map images between the transition process map image G22a and the transition result map image G23a, which are prepared by tilting the transition process map image G22a around the tilt axis L by the tilt angle θn, which is equal to n×θ/(N2+1). The device switches the map image on the display 16 from the plan view map image G21 to the transition result map image G23a via multiple transition process map images (i.e., from an image provided by φ1 to an image provided by φN1), the transition process map image G22a and multiple transition process map images (i.e., from an image provided by θ1 to an image provided by θN2) within the predetermine transition time. Thus, the up side of the right side region of the display region B, in which the route point I or the destination is disposed, is tilted to the up side of the display region B. Further, the down side of the left side region of the display region B is tilted to the down side of the display region B. Accordingly, the user can easily recognize the transition result map image G23a in the display region B. Further, the display region B is effectively utilized.

In the third embodiment, the device tilts the transition process map image G22a after the plan view map image G21 is rotated so that the transition result map image G23a is obtained. Alternatively, the device may generate the transition result map image G23a after the plan view map image G21 is tilted. Alternatively, the device may generate the transition result map image G23a by rotating and tilting the plan view map image G21 at the same time.

In the third embodiment, the navigation device displays the transition result map image G23a, which is prepared by tilting the up side of the right side region of the display region B to the up side of the display region B and tilting the down side of the left side region of the display region B to the down side of the display region B. Alternatively, the navigation device may display the transition result map image G23a, which is prepared by tilting the up side of the left side region of the display region B to the up side of the display region B and tilting the down side of the right side region of the display region B to the down side of the display region B. In this case, the user can easily recognize the transition result map image G23a in the display region B. Further, the display region B is effectively utilized.

The device may determine based on the following condition which map image the display 16 displays, the transition result map image G23a, which is prepared by tilting the up side of the right side region of the display region B to the up side of the display region B and tilting the down side of the left side region of the display region B to the down side of the display region B, or the transition result map image G23a, which is prepared by tilting the up side of the left side region of the display region B to the up side of the display region B and tilting the down side of the right side region of the display region B to the down side of the display region B. The condition is to reduce the rotation angle φ. Alternatively, the condition may be preliminary determined by the user, for example, the user may preliminary set the map image to be displayer 16 with using the operation unit 13. Alternatively, when the vehicle turns right at the next route point I, the device may display the transition result map image G23a, which is prepared by tilting the up side of the right side region of the display region B to the up side of the display region B and tilting the down side of the left side region of the display region B to the down side of the display region B. When the vehicle turns right at the next route point I, the device may display the transition result map image G23a, which is prepared by tilting the up side of the left side region of the display region B to the up side of the display region B and tilting the down side of the right side region of the display region B to the down side of the display region B. Specifically, the condition may depend on the turning direction at the next route point I.

Similar to the modification of the first embodiment, the device may generate the transition result map image G23a and the transition process map images with using the tilt axis L1, which is displaced from the tilt axis L to the starting point side of the current position P on the plan view map image G21.

### Fourth Embodiment

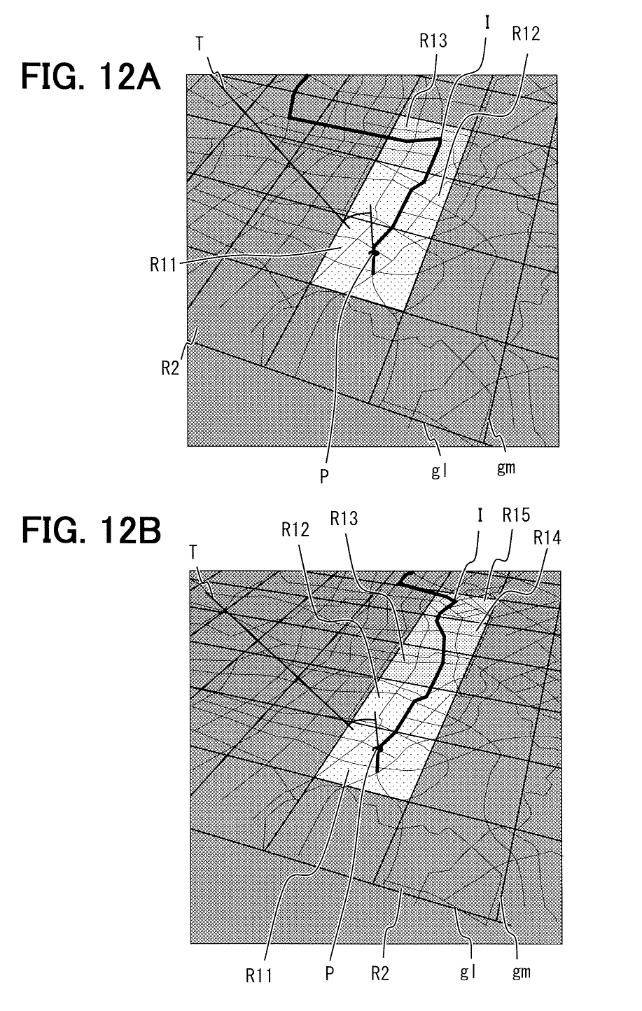

A navigation device according to a fourth embodiment will be explained with reference to FIGS. 12A and 12B.

In the first to third embodiments, when the map image to be displayer in the display region A or B of the display 16 is switched from the plan view map image to the transition result map image via the transition process map images, the user may not recognize the tilting degree and/or the rotating degree in some cases where the map includes a certain shape of the road. In the present embodiment, the navigation device generates the map image including a grid, and displays the map image with the grid ion the display region of the display 16.

Specifically, the navigation device generates the plan view map image, the transition process map images and the transition results map image, each of which includes multiple latitude grids and multiple longitude grids. The latitude grids are arranged at predetermined intervals and in parallel to the latitude extending in the east-west direction. The longitude grids are arranged at predetermined intervals and in parallel to the longitude extending in the north-south direction. In this case, the device generates the map image such that the predetermined interval of the latitude grids is equal to the predetermined interval of the longitude grids according to the scale of the map.

Each of the latitude and longitude grids is shown as a thick line, which is thicker than a road of the map image. The latitude and longitude grids define rectangular areas, each of which is surrounded with the latitude and longitude grids. The navigation device generates the plan view map image, the transition process map images and the transition results map image such that a background color of rectangular areas providing a route from the current position P to the next route point I has a contrast larger than the background color of other rectangular areas not providing the route between the current position P to the next route point I. For example, the background color of the rectangular areas providing a route from the current position P to the next route point I is pink, and the background color of the other rectangular areas not providing a route from the current position P to the next route point I is black. Thus, the rectangular areas providing the route from the current position P to the next route point I is emphasized in the plan view map image, the transition process map images and the transition results map image.

The navigation device generates the transition process map images so as to change the background color of the rectangular areas providing the route from the current position P to the next route point I at predetermined time intervals such as 0.1 seconds in an order from the rectangular area including the current position P to the rectangular area including the next route point in order of a distance from the current position P.

Thus, examples of the map images are shown in FIGS. 12A and 12B. FIG. 12A shows a case where the distance between the current position P and the next route point P is short. FIG. 12B shows a case where the distance between the current position P and the next route point P is long.

Comparing the map image in FIG. 12A with the map image in FIG. 12B, when the distance between the current position P and the next route point I is short, the shape of the rectangular areas R2 and R11-R15 surrounded with the latitude grids gm and the longitude grids gl becomes a square. Accordingly, the user can recognize the tilt angle of the map image according to the distortion of the rectangular area, i.e., the distance between two adjacent latitude grids gm, the slope of the latitude grids, the distance between two adjacent longitude grids gl and the slope of the longitude grids.

Further, as shown in FIGS. 12A and 12B, the background color of the rectangular areas R11-R15 providing the route between the current position P and the next route point I is different from the background color of the rectangular areas R2 not providing the route between the current position P and the next route point I. Thus, the user easily recognizes the distortion of the rectangular areas R11-R15. Thus, the user can recognize the sense of distance and the sense of direction according to the rectangular areas as an unit of meshes.

In FIG. 12A, the background color of the rectangular areas R11-R13 is changed rhythmically from black to pink at predetermined time intervals in the order of the distance from the current position P, i.e., in the order from the rectangular area R11 providing the current position P to the rectangular area R13 providing the next route point I via the rectangular area R12 on the route between the current position P and the next route point I. In FIG. 12B, the background color of the rectangular areas R11-R15 is changed rhythmically from black to pink at predetermined time intervals in the order of the distance from the current position P, i.e., in the order from the rectangular area R11 providing the current position P to the rectangular area R15 providing the next route point I via the rectangular areas R12-R14 on the route between the current position P and the next route point I. Thus, the user can easily recognize the distortion of the rectangular areas R11-R15.

In the fourth embodiment, the navigation device generates the plan view map image, the transition process map images and the transition results map image, each of which includes multiple latitude grids and multiple longitude grids. Alternatively, the grids may be displayed after the map image transition display process is executed. For example, the device may generate the plan view map image without the grid, and generate the transition process map images and the transition results map image including the latitude grids and longitude grids.

In the fourth embodiment, the navigation device generates the plan view map image, the transition process map images and the transition results map image, in which the rectangular areas R11-R15 providing the route between the current position P and the next route point I are emphasized such that the background color of the rectangular areas R11-R15 has the contrast largely different from the contrast of the background color of the other rectangular areas R2 not including the route. It is not necessary to emphasize the rectangular areas R11-R15 providing the route in all of the plan view map image, the transition process map images and the transition results map image. Alternatively, the device may generate the plan view map image with the rectangular areas R11-R15 having the contrast of the background color equal to the other rectangular areas R2, and generate the transition process map images and the transition results map image with the rectangular areas R11-R15 having the contrast of the background color largely different from the other rectangular areas R2. Alternatively, the plan view map image and the transition process map images may include the rectangular areas R11-R15, which has the contrast of the background color equal to the other rectangular areas R2, and the transition results map image may include the rectangular areas R11-R15, which has the contrast of the background color largely different from the other rectangular areas R2.

In the fourth embodiment, the transition process map images are displayed such that the background color of the rectangular areas providing the route between the current position P and the next route point I is changed rhythmically from black to pink at predetermined time intervals in the order of the distance from the current position P, i.e., in the order from the rectangular area providing the current position to the rectangular area providing the next route point I via the rectangular areas on the route between the current position P and the next route point I. Alternatively, the device may generate the transition process map images and the transition results map image such that the background color of the rectangular areas including the route from the current position to the next route point is gradually changed from black to pink in the order of the distance from the current position P, i.e., the background color is changed gradationally from black to pink in the order from the rectangular area providing the current position P to the rectangular area providing the next route point I via the rectangular areas providing the route. Alternatively, the device may generate the transition process map images and the transition results map image such that the background color of the rectangular areas including the route from the current position to the next route point is changed from black to pink at the same time.

### Other Embodiments

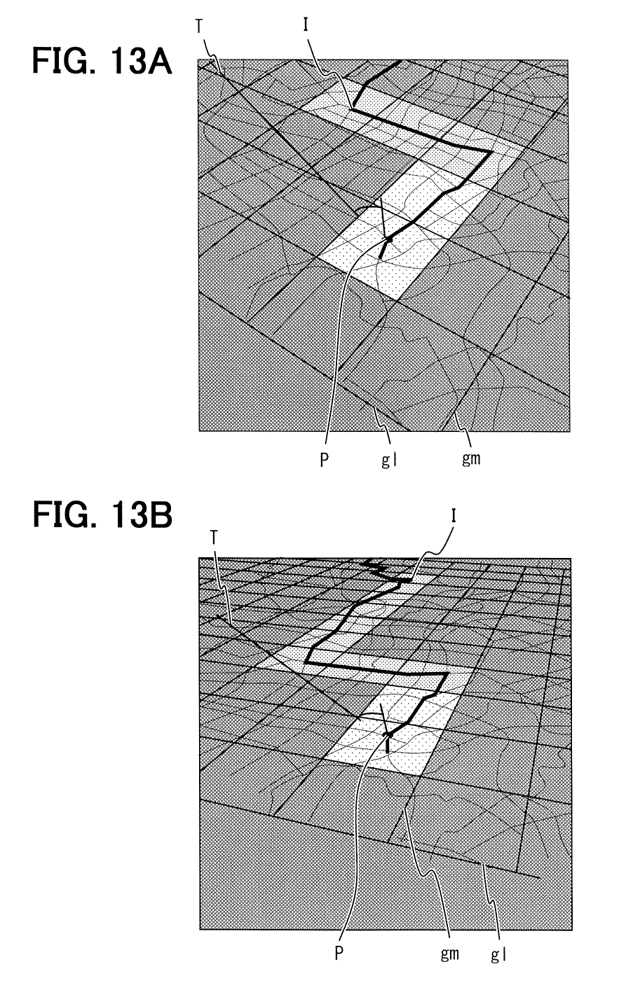

In the above embodiments, the navigation device generates the map image including the route from the current position to the next route point. Alternatively, the navigation device may generate the map image including the route from the current position to the predetermined ordinal number of the route point, which is specified by the user. For example, when the route guidance is executed, the user inputs the transition start instruction of the map image with using the push button of the operation unit 13. After that, the user may push several times during a predetermined time such as 5 seconds so that the number of pushing operations by the user specifies the predetermined ordinal number of the route point. For example, when the user pushes the button three times during the predetermined time, the predetermined ordinal number of the route point is the third route point. Thus, the map image including the route from the current position to the third route point is generated. The third route point is located at the third route point ahead of the current position. The ordinal number of the route point may be specified by the pushing time of the push button during the predetermined time or by inputting with the voice input device in the operation unit 13. FIG. 13A shows an example of the transition result map image in a case where the third route point I from the current position P is input. FIG. 13B shows an example of the transition result map image in a case where the fourth route point I from the current position P is input.

The straight line T in FIGS. 12A to 13B represents the direction from the current position as the reference to the destination. Specifically, the straight line T shows the direction of the position of the destination with reference to the current position as the reference. Thus, the straight line T may be displayed on the map images. Alternatively, the straight line T may not be displayed on the map images.

The navigation device includes the push button as the operation unit 13. When the user pushes the push button, the instruction for starting the map image transition display process is input into the device. The navigation device includes a touch panel and a voice input device as an input device. The instruction for starting the map image transition display process may be input into the device with using the touch panel or the voice input device.

The instruction for starting the map image transition display process is input into the device when the user pushes the push button, i.e., the execution condition for executing the map image transition display process is that the instruction for starting the map image transition display process with using the operation unit 13. Alternatively, the execution condition for executing the map image transition display process may be that the distance from the current position to the next route point on the route is equal to or smaller than a predetermined distance. Based on the execution condition, the navigation device starts the map image transition display process. Here, the predetermined distance is, for example, 1 kilometer.

In the above embodiments, the route includes the route point as a guidance object, at which the navigation device guides the route. The map image is displayed with using the route point. Alternatively, the point on the route, which is not displayed in the display region, may be used for generating the map image.

The above disclosure has the following aspects.

According to an aspect of the present disclosure, a navigation device includes: a map information memory for storing map information; a current position detector for detecting a current position; a route searching unit for searching a route from a starting point to a destination; a map image generating unit for generating a plan view map image including the current position and a part of the route according to the map information, a detected current position and a searched route; a display for displaying the plan view map image in a display region of the display; and a display controller for controlling the display. The map image generating unit defines a tilt axis, which is perpendicular to a straight line passing the current position and a certain point of the route not shown in the display region. The map image generating unit generates a transition result map image by tilting the plan view map image around the tilt axis so that the certain point is shown on an up side of the transition result map image in the display region. The map image generating unit generates a transition process map image, which is a halfway image between the plan view map image and the transition result map image. The display controller controls the display to switch from the plan view map image to the transition result map image via the transition process map image when a predetermined condition is satisfied.

In the above device, the display switches the plan view map image to the transition result map image via the transition process map image. Here, the scale of the transition result map image and the transition process map image is the same as the plan view map image. Further, even when the display switches the plan view map image to the transition result map image via the transition process map image, the current position is always displayed in the display region. Thus, the user does not lose recognition of a current position, a sense of distance and a sense of direction with respect to the current position. Further, since the transition result map image is displayed through the transition process map image, the route to the destination is intuitively recognized by the user.

Alternatively, the certain point may be a route point of the route, at which the navigation device guides the route in order to navigate the route.

Further, the map image generating unit may define a predetermined ordinal number of the route point as the certain point when the number of route points located between the current position and the destination is equal to or larger than a predetermined number. The map image generating unit may generate the transition result map image and the transition process map image with using the tilt axis perpendicular to the straight line passing the current position and the predetermined ordinal number of the route point when the number of route points located between the current position and the destination is equal to or larger than the predetermined number. In this case, the user can recognize a part of the route from the current position to the predetermined ordinal number of the route point intuitively.

Furthermore, the map image generating unit may define the destination as the certain point when the number of route points located between the current position and the destination is smaller than the predetermined number. The map image generating unit generates the transition result map image and the transition process map image with using the tilt axis perpendicular to the straight line passing the current position and the destination when the number of route points located between the current position and the destination is smaller than the predetermined number. In this case, the user can recognize the route from the current position to the destination intuitively.

Alternatively, the predetermined number may be equal to or larger than two. The map image generating unit defines one of the route points between the current position and the destination as the certain point when the number of route points located between the current position and the destination is smaller than the predetermined number. The map image generating unit generates the transition result map image and the transition process map image with using the tilt axis perpendicular to the straight line passing the current position and the one of the route points when the number of route points located between the current position and the destination is smaller than the predetermined number. In this case, the user can recognize a part of the route from the current position to the one of the route points between the current position and the destination intuitively.

Alternatively, the map image generating unit may rotate the plan view map image around the current position so that the certain point is located on an up side of the current position of a rotated plan view map image before, after or at the same time the plan view map image is tilted around the tilt axis. Here, when the display displays a map image in a north up manner, or when the display displays the map image in a head up manner, the current position is displayed at the center of the display region or on a down side of the center of the display region in the right-left direction of the display region. The certain point on the route may be located on a left side region, a right side region or a down side region of the display region. Accordingly, if the right side region is tilted to the right side and the left side region is tilted to the left side in the transition result map image, or if the down side region is tilted to the down side and the up side region is tilted to the up side in the transition result map image, the difficulty in viewing the transition result map image may occur. When the map image generating unit rotates the plan view map image around the current position so that the certain point is located on an up side of the current position of a rotated plan view map image, the certain point of the route is located on the up side of the display region. Thus, since the certain point is displayed on the up side of the transition result map image, the user easily see the transition result map image.

Alternatively, the map image generating unit may rotate the plan view map image around the current position so that the certain point is located on an up side of a right side region of a rotated plan view map image in the display region before, after or at the same time the plan view map image is tilted around the tilt axis. In this case, the user can easily see the transition result map image.

Alternatively, the map image generating unit may rotate the plan view map image around the current position so that the certain point is located on an up side of a left side region of a rotated plan view map image in the display region before, after or at the same time the plan view map image is tilted around the tilt axis. In this case, the user can easily see the transition result map image.

Alternatively, the predetermined condition may be satisfied when a distance between the current position and the certain point is equal to or smaller than a predetermined distance. Thus, the display controller automatically controls the display to switch from the plan view map image to the transition result map image via the transition process map image when a predetermined condition is satisfied. Thus, the operation load of the user is reduced. Here, the predetermined distance is, for example, 1 kilometer.

Alternatively, the navigation device may further include: an operation unit, which is operated by a user. The predetermined condition is satisfied when the user inputs an execution instruction into the navigation device with the operation unit. Thus, when the user requires, the display controller controls the display to switch from the plan view map image to the transition result map image via the transition process map image when a predetermined condition is satisfied.

Further, the operation unit may include a push button. The predetermined condition is satisfied when the user pushes the push button.

Alternatively, the tilt axis may pass the current position.

Alternatively, the tilt axis may pass a point on the plan view map image, which is located on a starting point side from the current position. In this case, an area of the transition result map image disposed on the destination side from the current position in a case where the tilt axis may pass a point on the plan view map image, which is located on a starting point side from the current position, is larger than a case where the tilt axis may pass the current position. Accordingly, the display region is effectively utilized.

Alternatively, at least one of the plan view map image, the transition result map image and the transition process map image may include a plurality of grids, which are arranged at predetermined intervals. The display displays the at least one of the plan view map image, the transition result map image and the transition process map image with the plurality of grids. In this case, the user can accurately recognize the tilt angle of the plan view map image in view of the distance between two adjacent grids and the slope of the grids.

Further, the plurality of grids may include a plurality of latitude grids and a plurality of longitude grids. Each latitude grid is in parallel to the latitude, and each longitude grid is in parallel to the longitude. In this case, the user can recognize the direction of the route to the destination intuitively.

Alternatively, the plurality of grids may provide a plurality of rectangular areas, each of which is surrounded with a pair of corresponding latitude grids and a pair of corresponding longitude grids. At least one rectangular area including the route has a contrast of a background color, which is largely different from other rectangular areas not including the route, so that the at least one rectangular area is emphasized on the at least one of the plan view map image, the transition result map image and the transition process map image. In this case, the user can easily recognize the distance between two adjacent latitude girds, the slope of the latitude grids, the distance between two adjacent longitude girds, and the slope of the longitude grids. The user can recognize the sense of distance and the sense of direction according to the rectangular area as a unit of the grids.

Alternatively, each grid may be shown by a thick line, which is thicker than a road, so that the grid is emphasized on the at least one of the plan view map image, the transition result map image and the transition process map image.

Alternatively, the navigation device may further include: a push button. The predetermined condition is satisfied when the user pushes the push button. The certain point is a route point of the route, at which the navigation device guides the route in order to navigate the route. The tilt axis passes the current position. The plan view map image is tilted around the tilt axis by a tilt angle so that the transition result map image is generated. The map image generating unit generates the transition process map image by tilting the plan view map image around the tilt axis by a part of the tilt angle.

Further, the route point may include at least one of an intersection, at which a vehicle turns right or left, a branch point, an entrance and an exit of an interchange in a high way, and a stopover. The certain point is a next route point. The transition process map image includes a plurality of transition process map image elements. The tilt angle is divided by the number of the plurality of transition process map image elements so that a tilt angle division unit is obtained. The map image generating unit generates each transition process map image element by tilting the plan view map image around the tilt axis by the tilt angle division unit multiplied by a corresponding number.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A navigation device comprising:
a map information memory for storing map information;
a current position detector for detecting a current position;
a route searching unit for searching a route from a starting point to a destination;
a map image generating unit for generating a plan view map image including the current position and a part of the route according to the map information, a detected current position and a searched route;
a display for displaying the plan view map image in a display region of the display; and
a display controller for controlling the display,
wherein the map image generating unit defines a tilt axis, which is perpendicular to a straight line passing the current position and a certain point of the route not shown in the display region,
wherein the map image generating unit generates a transition result map image by tilting the plan view map image around the tilt axis so that the certain point is shown on an up side of the transition result map image in the display region,
wherein the map image generating unit generates a transition process map image, which is a halfway image between the plan view map image and the transition result map image, and
wherein the display controller controls the display to switch from the plan view map image to the transition result map image via the transition process map image when a predetermined condition is satisfied.

2. The navigation device according to claim 1,
wherein the certain point is a route point of the route, at which the navigation device guides the route in order to navigate the route.

3. The navigation device according to claim 2,
wherein the map image generating unit defines a predetermined ordinal number of the route point as the certain point when the number of route points located between the current position and the destination is equal to or larger than a predetermined number, and
wherein the map image generating unit generates the transition result map image and the transition process map image with using the tilt axis perpendicular to the straight line passing the current position and the predetermined ordinal number of the route point when the number of route points located between the current position and the destination is equal to or larger than the predetermined number.

4. The navigation device according to claim 3,
wherein the map image generating unit defines the destination as the certain point when the number of route points located between the current position and the destination is smaller than the predetermined number, and
wherein the map image generating unit generates the transition result map image and the transition process map image with using the tilt axis perpendicular to the straight line passing the current position and the destination when the number of route points located between the current position and the destination is smaller than the predetermined number.

5. The navigation device according to claim 3,
wherein the predetermined number is equal to or larger than two,
wherein the map image generating unit defines one of the route points between the current position and the destination as the certain point when the number of route points located between the current position and the destination is smaller than the predetermined number, and
wherein the map image generating unit generates the transition result map image and the transition process map image with using the tilt axis perpendicular to the straight line passing the current position and the one of the route points when the number of route points located between the current position and the destination is smaller than the predetermined number.

6. The navigation device according to claim 1,
wherein the map image generating unit rotates the plan view map image around the current position so that the certain point is located on an up side of the current position of a rotated plan view map image before, after or at the same time the plan view map image is tilted around the tilt axis.

7. The navigation device according to claim 1,
wherein the map image generating unit rotates the plan view map image around the current position so that the certain point is located on an up side of a right side region of a rotated plan view map image in the display region before, after or at the same time the plan view map image is tilted around the tilt axis.

8. The navigation device according to claim 1,
wherein the map image generating unit rotates the plan view map image around the current position so that the certain point is located on an up side of a left side region of a rotated plan view map image in the display region before, after or at the same time the plan view map image is tilted around the tilt axis.

9. The navigation device according to claim 1,
wherein the predetermined condition is satisfied when a distance between the current position and the certain point is equal to or smaller than a predetermined distance.

10. The navigation device according to claim 1, further comprising:
an operation unit, which is operated by a user,
wherein the predetermined condition is satisfied when the user inputs an execution instruction into the navigation device with the operation unit.

11. The navigation device according to claim 10,
wherein the operation unit includes a push button,
wherein the predetermined condition is satisfied when the user pushes the push button.

12. The navigation device according to claim 1,
wherein the tilt axis passes the current position.

13. The navigation device according to claim 1,
wherein the tilt axis passes a point on the plan view map image, which is located on a starting point side from the current position.

14. The navigation device according to claim 1,
wherein at least one of the plan view map image, the transition result map image and the transition process map image includes a plurality of grids, which are arranged at predetermined intervals, and
wherein the display displays the at least one of the plan view map image, the transition result map image and the transition process map image with the plurality of grids.

15. The navigation device according to claim 14,
wherein the plurality of grids include a plurality of latitude grids and a plurality of longitude grids, and
wherein each latitude grid is in parallel to the latitude, and each longitude grid is in parallel to the longitude.

16. The navigation device according to claim 15,
wherein the plurality of grids provide a plurality of rectangular areas, each of which is surrounded with a pair of corresponding latitude grids and a pair of corresponding longitude grids, and
wherein at least one rectangular area including the route has a contrast of a background color, which is largely different from other rectangular areas not including the route, so that the at least one rectangular area is emphasized on the at least one of the plan view map image, the transition result map image and the transition process map image.

17. The navigation device according to claim 14,
wherein each grid is shown by a thick line, which is thicker than a road, so that the grid is emphasized on the at least one of the plan view map image, the transition result map image and the transition process map image.

18. The navigation device according to claim 1, further comprising:
a push button,
wherein the predetermined condition is satisfied when the user pushes the push button,
wherein the certain point is a route point of the route, at which the navigation device guides the route in order to navigate the route,
wherein the tilt axis passes the current position,
wherein the plan view map image is tilted around the tilt axis by a tilt angle so that the transition result map image is generated,
wherein the map image generating unit generates the transition process map image by tilting the plan view map image around the tilt axis by a part of the tilt angle.

19. The navigation device according to claim 18,
wherein the route point includes at least one of an intersection, at which a vehicle turns right or left, a branch point, an entrance and an exit of an interchange in a high way, and a stopover,
wherein the certain point is a next route point,
wherein the transition process map image includes a plurality of transition process map image elements,
wherein the tilt angle is divided by the number of the plurality of transition process map image elements so that a tilt angle division unit is obtained, and
wherein the map image generating unit generates each transition process map image element by tilting the plan view map image around the tilt axis by the tilt angle division unit multiplied by a corresponding number.
